(19) United States
(12) Patent Application Publication
(10) Pub. No.: US 2012/0209887 A1
(43) Pub. Date: Aug. 16, 2012

(54) System, Process and Article of Manufacture for Automatic Generation of Subsets of Existing Databases

(75) Inventors: Richard Paul Jones, Purcell, OK (US); David Stuart Evans, Pelham, NY (US)

(73) Assignee: STANDARDWARE, INCORPORATED, Pelham Manor, NY (US)

(21) Appl. No.: 13/345,693

(22) Filed: Jan. 7, 2012

Related U.S. Application Data
(60) Provisional application No. 61/441,957, filed on Feb. 11, 2011.

(51) Int. Cl. G06F 17/30

(52) U.S. Cl. 707/802; 707/E17.005

(57) ABSTRACT

A system, process and article of manufacture automatically provisions software in a data processing system incorporating a subset of preexisting database management applications and their related artifacts. A user request is received to generate the subset from the existing database management application. A virtual data processing machine is created in the data processing system. A subset of the existing database management application comprising less than the entire existing database management application is created in the virtual data processing machine.

### FIELD OF THE INVENTION

The present invention relates to automatic generation of related applications and related control information incorporating subsets of preexisting programs and related control information in a Database Subsystem. More particularly, it relates to such automated generation of applications and databases in a virtual machine environment.

### BACKGROUND OF THE INVENTION

The IMS (Information Management System) product from IBM has been around for over 40 years. During that time programmers have written billions of lines of code for business applications built around the robust features of IMS. Most of these applications are very complex and use many IMS databases to provide the business functions the company needs to operate the business. In most cases, the people who originally wrote these applications have either retired, moved into management positions or changed professions.

Companies have a large collection of application programs that work but have little idea, diagrams, flowcharts or documentation of which applications are needed to make the IMS system work. If a change is needed most project managers have little idea which programs will need to be changed, and project estimates are a challenge and often underestimate the complexities of projects cost and time of completion.

Companies running IMS never delete any programs and related control information in fear that something will break in their production systems which would cause an outage and cost the companies millions of dollars in downtime. Companies rely on IMS to run their business and as businesses change, applications need changes to meet business requirements.

The problem is that over the years IMS systems have become massive in size and hard to manage. In order to facilitate changes to applications, programmers spend an enormous amount of time studying programs that ‘might be affected’ by a change to the application code.

IMS has many artifacts or control information that make up an application. These artifacts describe the databases, what type of access the program is allowed to do, the number of databases a program can access, what type of operations the program can perform to a database, if a user can access the application via a terminal or batch processing, to name a few examples.

For the purposes of this document, IMS artifacts are defined below:
1. Programs—Programs are written in many computer languages. Current languages are COBOL, Assembler, PL1, C, and JAVA.
2. PSB—Program Specification Block.
3. DBD—Data Base Description.
4. DB2 tables.
5. MFS—Message Format Services.
6. JCL—Job Control Language.

The Standardware product COPE (Complete Online Programming Environment) creates virtual IMS systems to allow efficient use of the company's resources and greatly speeds up the process of creating IMS Systems for development and testing. COPE creates Logical IMS systems within a Physical IMS System. COPE allows for up to 255 Logical Systems to be created in a single Physical IMS System. Further details on the COPE product are available in the COPE General Information Manual, available at www.standardware.com, the disclosure of which is incorporated by reference herein.

The automatic generation of virtual machines in data processing systems and their provisioning with software is known in the art. For example, U.S. Pat. No. 7,577,722 and U.S. Patent Application Publication 2010/0131948 disclose the automatic provisioning of virtual machines and software. However, these prior art systems and methods contemplate the creation of entire duplicates of programs and associated databases. While this can be done with large scale and complex legacy software for mainframe systems, such as software running under IMS, doing so is time consuming, wasteful and usually requires some manual intervention by a skilled data processing professional.

### SUMMARY OF THE INVENTION

It is an object of this invention to provide a system, process and article of manufacture for the automatic provisioning of software incorporating a subset of preexisting database management applications and their related artifacts.

It is a further object of the invention to provide such a system, process and article of manufacture which minimizes or eliminates the need for human involvement after an initial request for automatic provisioning.

It is another object of the invention to provide such a system, process and article of manufacture which creates a virtual system for the automatic provisioning of the subset database management application and its related artifacts.

In accordance with the invention, a system for the automatic generation of a subset of an existing database management application including a plurality of artifacts in the system includes an input for receiving a user request to generate the subset from the existing database management application. A processing unit is configured to create a virtual data processing machine in the system. The processing unit is further configured to create the subset of the existing database management application comprising less than the entire existing database management application in the virtual data processing machine.

Further in accordance with the invention, a process for the automatic creation of a subset of an existing database management application including a plurality of artifacts in a data processing system includes receiving a user request to generate the subset from the existing database management application. A virtual data processing machine is created in the data processing system. A subset of the existing database management application comprising less than the entire existing database management application is created in the virtual data processing machine.

Still further in accordance with the invention, an article of manufacture for the automatic generation of a subset of an existing database management application including a plurality of artifacts includes a computer readable storage medium having stored therein a first program segment for receiving a user request to generate the subset from the existing database management application. A second program segment is for creating a virtual data processing machine in the data processing system. A third program segment is for creating a subset of the existing database management application comprising less than the entire existing database management application in the virtual data processing machine.

The attainment of the foregoing and related objects, advantages and features of the invention should be more readily apparent to those skilled in the art after review of the following detailed description of the invention, taken together with the drawings, in which:

### BRIEF DESCRIPTION OF THE DRAWINGS

FIG. 1 is a graphical representation of a first portion of a user interface for a system and process and obtained by using the article of manufacture of an embodiment of the invention.

FIG. 2 is a graphical representation of a data model used in an embodiment of the invention.

FIG. 3 is a graphical representation of a second portion of a user interface for a system and process and obtained by using the article of manufacture of an embodiment of the invention.

FIG. 4 is a graphical representation of a third portion of a user interface for a system and process and obtained by using the article of manufacture of an embodiment of the invention.

FIG. 5 is a graphical representation of a fourth portion of a user interface for a system and process and obtained by using the article of manufacture of an embodiment of the invention.

FIG. 6 is a graphical representation of a fifth portion of a user interface for a system and process and obtained by using the article of manufacture of an embodiment of the invention.

FIG. 7 is a graphical representation of a sixth portion of a user interface for a system and process and obtained by using the article of manufacture of an embodiment of the invention.

FIG. 8 is a graphical representation of a seventh portion of a user interface for a system and process and obtained by using the article of manufacture of an embodiment of the invention.

FIG. 9 is a graphical representation of an eighth portion of a user interface for a system and process and obtained by using the article of manufacture of an embodiment of the invention.

FIG. 10 is a graphical representation of a ninth portion of a user interface for a system and process and obtained by using the article of manufacture of an embodiment of the invention.

FIG. 11 is a graphical representations of data structures used in an embodiment of the system, process and article of manufacture of the invention.

### DETAILED DESCRIPTION OF THE INVENTION

The COPE product virtualizes IMS environments. Many virtual ‘Logical Systems’ exist simultaneously in a single IMS ‘Physical System’.

Environments are defined to IMS via a process of copying IMS definitions into the COPE system. COPE maintains a catalog of the definitions and compiles the components into various IMS load libraries. When the environments have been defined, the program libraries, database datasets and DB2 tables must be created for every environment before developers can start work.

A typical IMS system has many thousands of interrelated definitions (PSBs DBDs Stage 1 Dynalloc MFS etc). Applications also have Copybooks and macros that must always be synchronized correctly with the IMS definitions as well as the JCL required to execute batch and BMP jobs.

If a developer requires a new environment to be created for testing a change, considerable work must be performed before it becomes available.

COPE has the ability to automatically clone entire IMS environments via a sibling definition. Developers can be assigned a cloned environment and may then change components that override the cloned specifications. Changes in applications PSBs DBDs etc are easy to implement.

The COPE ICE Feature allows the environment required for development and testing one or more applications to be created together with the data that the applications require. After the initial setup, the environment creation process is designed to be automatic and not require the intervention of Database Administrators or Systems Personnel. The advantage of ICE is to minimize the unnecessary creation of unused pieces of a large system and to reduce the requirement for skilled technicians as well as reducing the errors that inevitably occur when many components have to be compiled and datasets populated.

Depending on the number of applications, environments may be created in hours or days when weeks or months were required without ICE.

### ICE Setup

One or more copies of the ‘Production’ IMS system have to be created using COPE tools. This involves importing IMS definitions (DBD PSB Stage 1 etc) and recompiling them so that they can run in a COPE IMS Physical System.

Jobs that unload and reload DB2 tables and DL/1 databases have to be created for all DB2 and DL/1 applications.

An ICE ‘Discovery’ process is initiated that extracts information from the imported Logical System definitions from the initial setup and automatically loads it into an ICE dictionary. The dictionary is updated with database and DB2 table creation JCL constructed for the initial test system.

After the ‘Discovery’ process an ICE ‘Operation’ can be defined for a ‘Collection’ of programs or database objects to be copied to a Logical System. The ‘Operation’ may be ‘Analyzed’ to determine its scope and correctness and then ‘Executed’ to create a new COPE environment.

An ICE ‘Execution’ operation generates many jobs that copy source and load definitions from one COPE Logical System to another and also create databases and DB2 tables. The generated jobs execute in the correct sequence and are designed to be restarted in the event of unforeseen problems.

### The ICE Application Menu

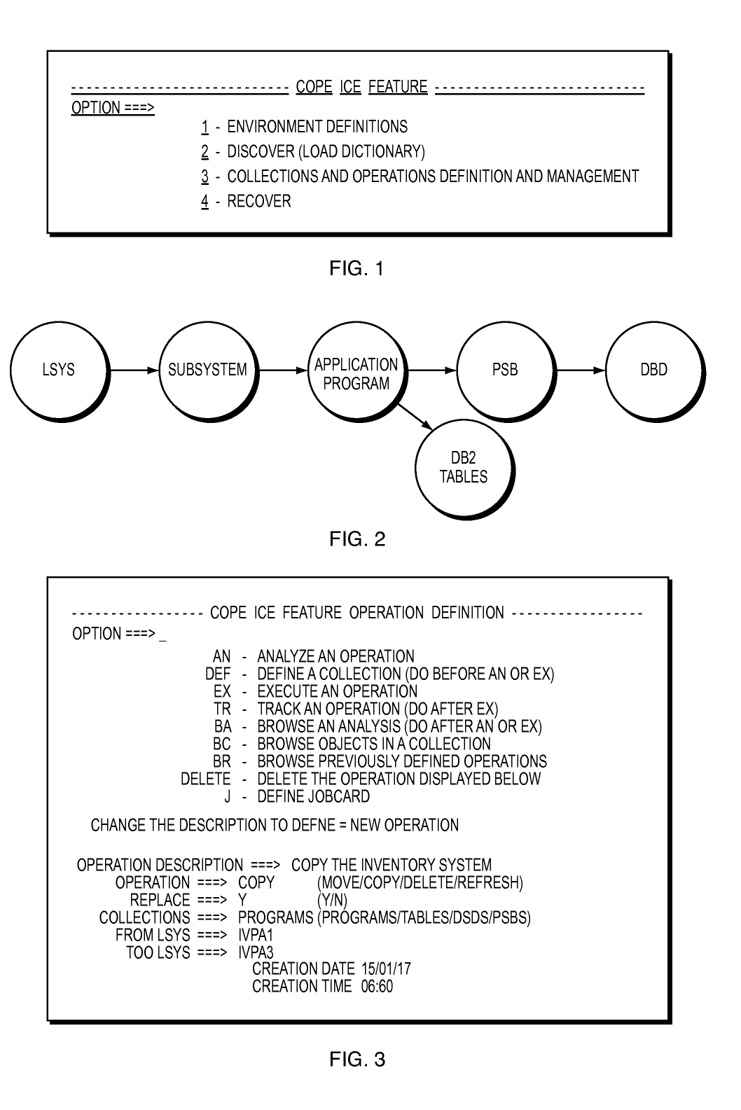

The menu shown in FIG. 1 allows access to all ICE Functions. Option 1 is used before any other activity is performed to define environmental parameters. Option 2 is used to load the ICE Dictionary from Definitions imported into a COPE logical system. It also allows access to the ICE dictionary for further definition and testing of items such as Database creation JCL. Option 3 is used to define movement of related objects between Logical Systems. Option 4 allows the recovery of a modified environment to a previous state.

### The ICE Data Model for Collection

ICE transfers ‘Collections’ of objects from one logical system to another. ‘Collection’ specification is based on the data model shown in FIG. 2. The internal data model is far more complicated, but the model that users use is shown in this figure.

Every Logical System has multiple subsystems in it. Each subsystem has multiple application programs. Each program has a PSB which references multiple DBDs. Application Programs access DB2 tables. ICE allows ‘Collections’ of Subsystems, Programs, Tables, PSBs or DBDs within an Logical System.

To define a collection, the user may begin at any node and go back to the previous node. For instance, if the ‘DB2 Table’ node was initially accessed and a set of tables selected, a command could be issued that would select all programs that used the tables. If the ‘Program Collection’ was copied from one Logical System to another PSBs, DBDs, databases, Stage 1 definitions, Dynalloc definitions would also be copied and the associated databases and tables created. In addition to those DB2 tables initially selected all other DB2 tables that the application programs accessed would also be created. If a ‘Collection’ of databases was made, only the Stage 1 definitions, Dynalloc and DBDs would be transferred and the DL/1 databases created.

### Defining an ICE Operation

The ICE Operation Definition panel is shown in FIG. 3. Commands can be entered as follows:
AN Analyze an Operation
DEF Define a Collection
EX Execute an Operation
TR Track an Operation Execution
BA Browse an analysis of an Operation
BC Browse the Objects in a Collection
BR Browse previously defined Operations

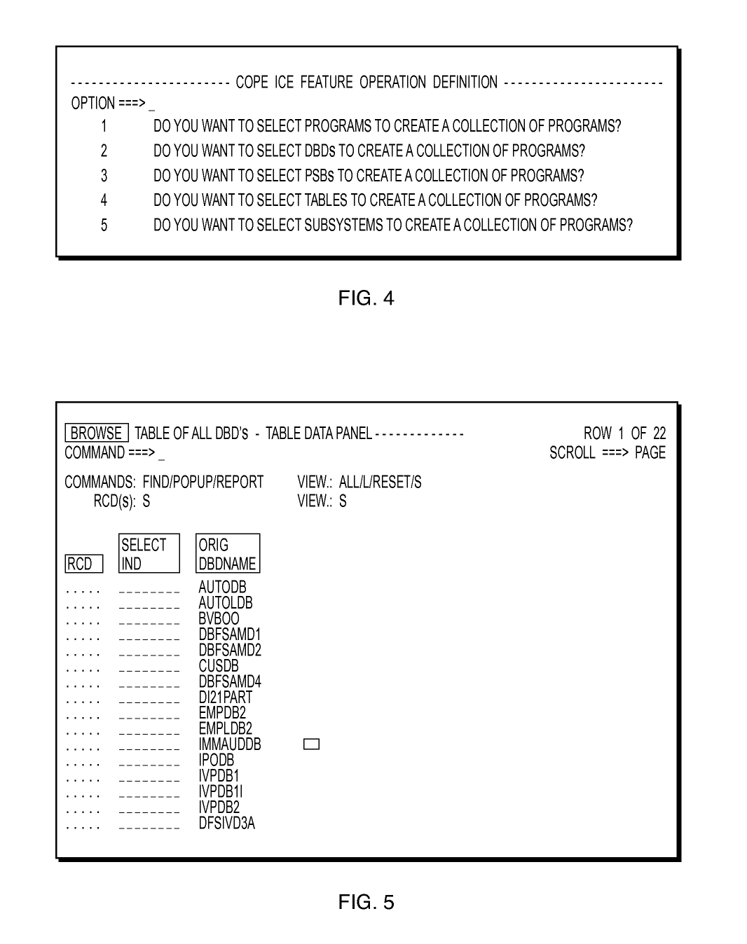

When an Operation is specified, a selection panel is displayed that allows the user to define the objects that the Collection is related to. The Object selection panel for moving programs is shown in FIG. 4.

After the selection is made a further selection panel, shown in FIG. 5, is displayed that allows the Objects to be selected. When the definition process has been completed, the results may be viewed with the BC command.

The AN command submits a background job that generates the jobs that will perform the Operation. The BA command allows the user to review and edit the generated jobs. The EX command may be issued without doing an analysis and will directly generate and submit the jobs required to perform the operation. During execution of an Operation, the progress of the execution of the jobs may be viewed with the TR command.

### Objects Processed by ICE

The following objects may be moved or copied by ICE Operations:
1. Program Source
2. Program subroutine source
3. Program COPYLIB members
4. DBD source
5. PSB source
6. Stage 1 Source
7. Dynalloc source
8. Load modules
9. DBRM modules
10. MFS
11. Batch and BMP JCL

The following Objects are automatically compiled for an operation
1. DBDs
2. PSBs
3.Stage 1 (Definitions are updated in executing system via DRD)
4. Dynalloc
5.DB2 Plans
6. MFS

DBRC database definitions are constructed for an Operation.

The following Databases are automatically created for an Operation
1. DB2 Tables
2. DL/1 Databases

### Additional Capabilities of the ICE Feature

ICE supports different DB2 subsystems for different Logical Systems, or all Logical Systems may share a single DB2 subsystem. If table prefixes are coded in the application, ICE has the capability of removing them before a Bind is made. All DL/1 database organizations are supported. Recovery from any Operation is supported. Recovery reverses the changes made between the pair of Logical Systems defined in an Operation. The ICE dictionary may be entirely refreshed from a COPE Logical System or changes to individual components may be specified manually. A ‘Snippit’ mechanism is provided for Delete/Unload/Load JCL creation for DL/1 Databases and DB2 tables.

### Technical Overview for RD/z and COPE ICE Interface

RDz is organized into different perspectives and views within each perspective. The different perspectives take most (if not all) of the window of the Eclipse instance. The views within each perspective relate to the function (or type) of perspective. An example is the z/OS Project perspective which shows views (or tabs) for Remote Systems, z/OS File System Mapping, Properties etc with each view showing detail relating to the z/OS project perspective.

COPE ICE has its own perspective and views depending on how ICE is being used. There is an ICE admin perspective which would show COPE system related information such as Application System Group view, Migrating Systems Status view, Total number of Logical Systems view (with details about the Logical System i.e. PSBs, DBDs, Libraries allocated etc), and other system information a COPE ICE admin person would need.

There is an ICE developer perspective which would show the developer details about their own logical system. This perspective might not be needed but an ICE view within their own development perspective should be available to the developer which would expose the details of their Logical System being used.

ICE may need a TCP/IP socket program to exchange information with RDz, the data exchanged with RDz will probably be in an XML format and ICE will need to allow for multiple calls to populate each view of RDz.

ICE will need to upload the COPE ICE Collection Dictionary to RDz via XML which is a large table of all the related data objects for a sub-system.

It is important that RDz drive the ICE request and ICE will report back any data requested. An example would be a status request (via RDz refresh) which will return the status of long running task such as data base load completion (or in progress), system migration status completion (or progress so far) etc.

We allow for a push request that allows ICE to inform RDz of certain events that have occurred in the different environments such as IMS error messages that normally occur in a working IMS system.

The following description provide more details of:
1. A description the COPE User Interface (UI) between the COPE TCP SERVICE (COPESERV) and a RD/z client machine. This includes the displaying of data characteristics in a plugin, Uniform Resource Identifier (URI) and sample XML data received from COPESERV for the COPE UI to interact with.
2. A high level overview of the COPESERV Components which will service the COPE UI request and XML responses and a description of the COPE Application.
3. The CICE_XML scheme and the assembler copy member CICEXMLS to provide the Data Structures used by the COPESERV application to generate the XML needed for the COPE UI.

### RD/z Characteristics

RD/z is projects displays perspectives and views within each perspective. The perspectives take most of the window of the Eclipse instance.

The views within each perspective relate to the function of the perspective. An example is the z/OS Project perspective which shows views for Remote Systems, z/OS File System Mapping, Properties etc with each view showing detail relating to the z/OS project perspective.

### COPE UI Characteristics

The COPE UI is to be written as a plugin for RD/z. The RD/z plugin should follow the same execution and display characteristics as other RD/z plugins regarding fonts, icons, tree structures, perspectives, views, drag and drop etc. The display characteristics we will use in this document are a Windows Explorer type of UI for displaying the COPE ICE assets or data.

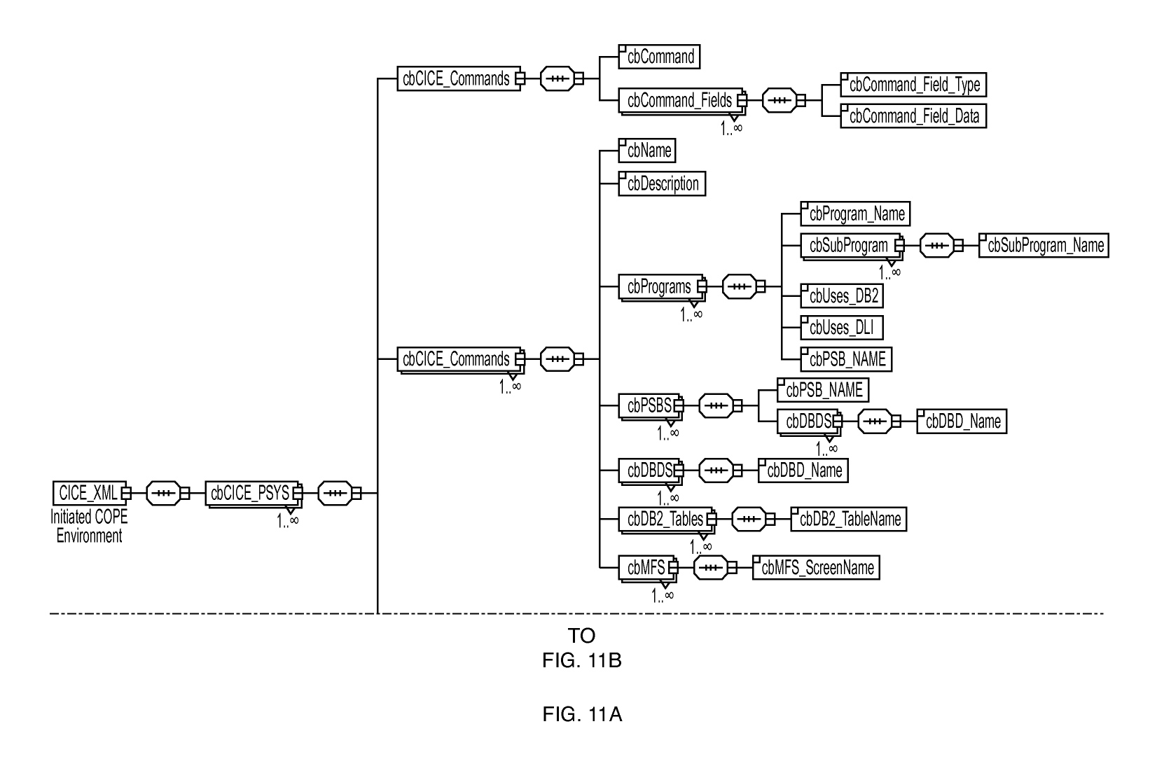

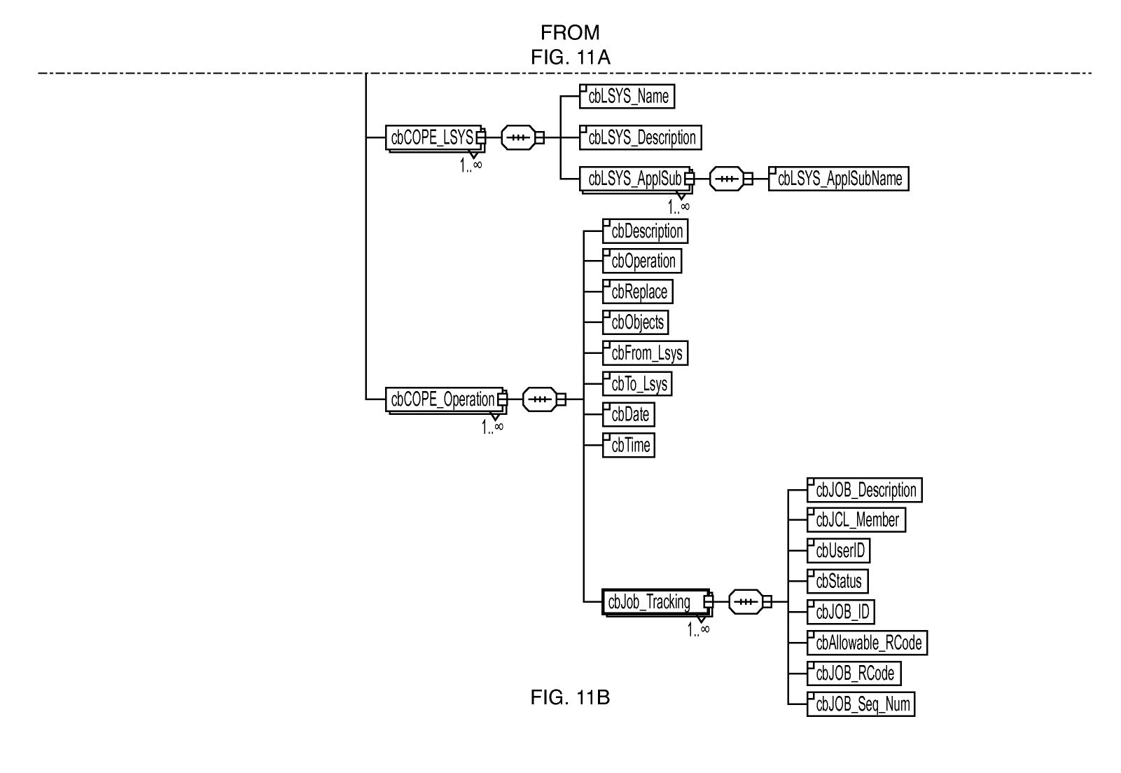

The COPE UI will produce a COPE ICE Perspective and will have 4 views. Each view will contain data that will be retrieved from the COPESERV Service or will be populated with values that are known to the COPE UI from the CICE_XML scheme (see FIG. 11).

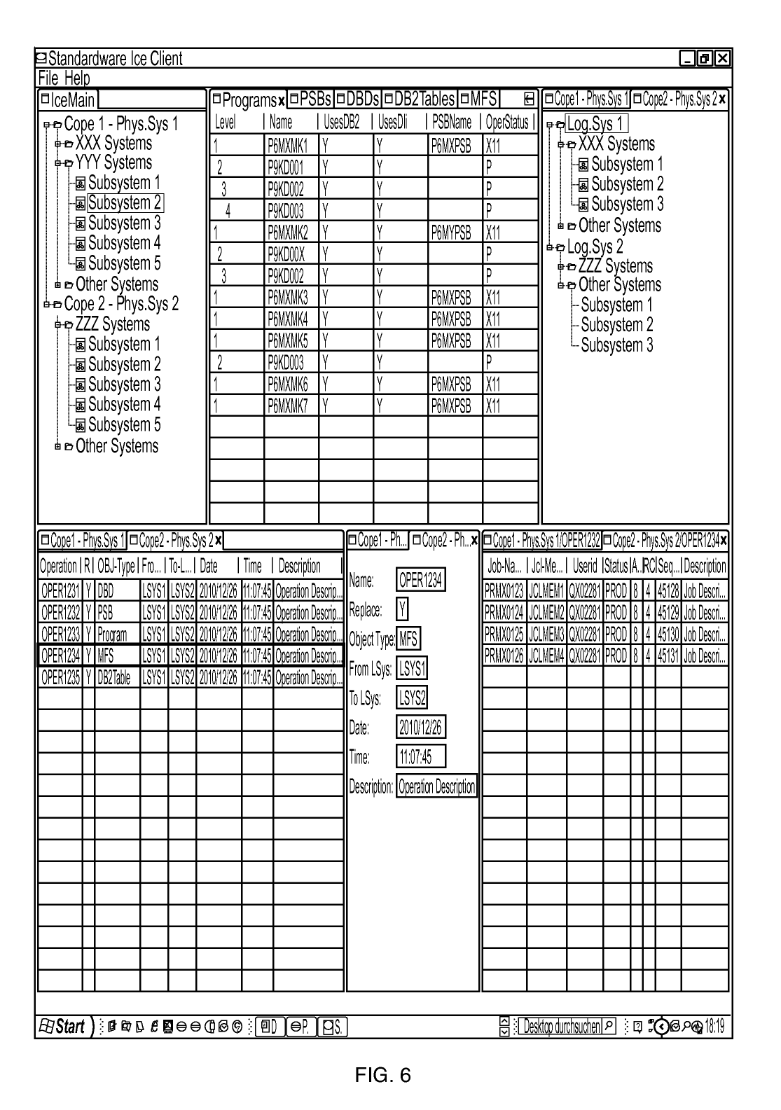

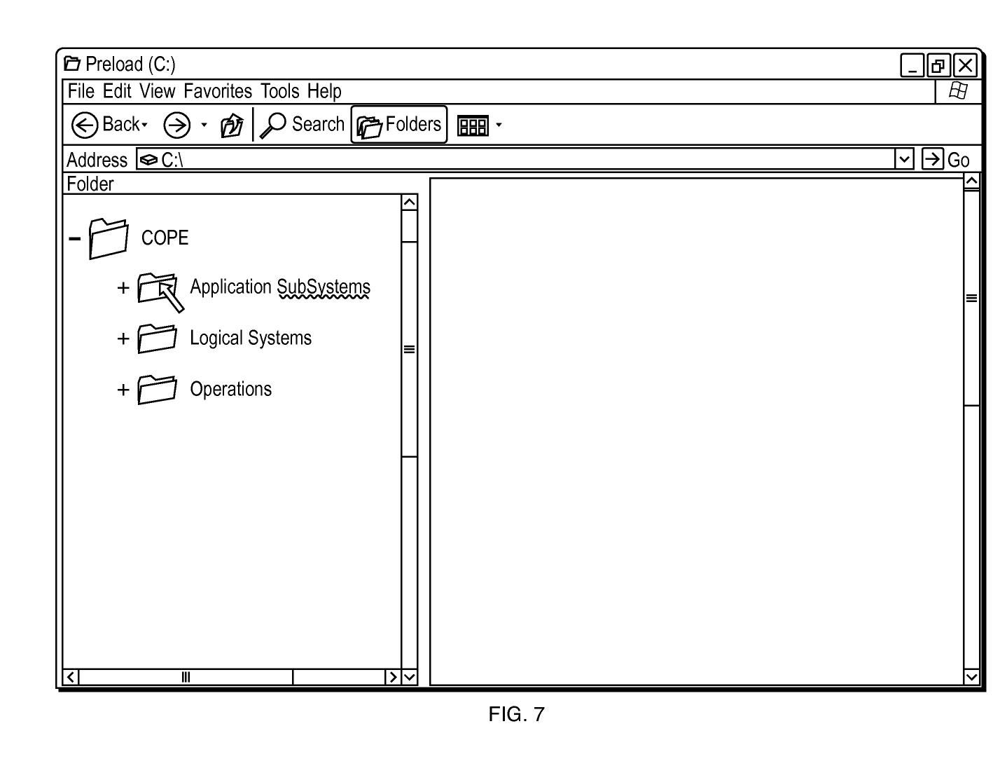

The contents of all the views are shown in FIG. 6. Each view will behave as all RD/z views do in that they will have maximize, minimize, close and tabs (at the top of each view).

### COPE ICE Uniform Resource Identifier (URI)

The COPE ICE URI is the mechanism that allows the UI to drive the COPESERV application. The URI can be equated to a data area the UI can pass to the COPESERV application. The URI has the following format.

/COPESERV/{resource type}/{resource name}/{command}

COPESERV is the target server application and must be present on all requests from the UI.

Resource type is the resource or node name (which matches the XML scheme) for which the request is made and is typically followed by the specific resource name. However, the resource type can be repeated for additional resource types and many combinations of resource type/resource name can occur within a URI.

If the resource name is not followed by a command, the COPESERV Service would produce all the XML nodes that are part of the resource name.

For the purposes of this document the CICE_XML scheme should be referred to when referencing the resource type for the URI. The resource name is the specific name for the resource that is retrieved from the COPESERV Service and returned to the UI via XML.

The only known exception to the URI and the resource type names matching the XML is the resource type of Server_Management. The Server_Management resource type is used to communicate from the COPE UI to the COPESERV Service application program for COPESERV only functions (i.e. shutdown, trace, dump etc).
Sample 1. URI=/COPESERV/{COPE_PSYS}/Appl_Subsystem/

Sample 1 URI would be generated by the COPE UI when the RD/z user clicks on the Application SubSystems folder displayed in the COPE UI (see FIG. 7). The URI would be sent to the COPESERV Service which would retrieve all the Application Subsystems for a COPE System.

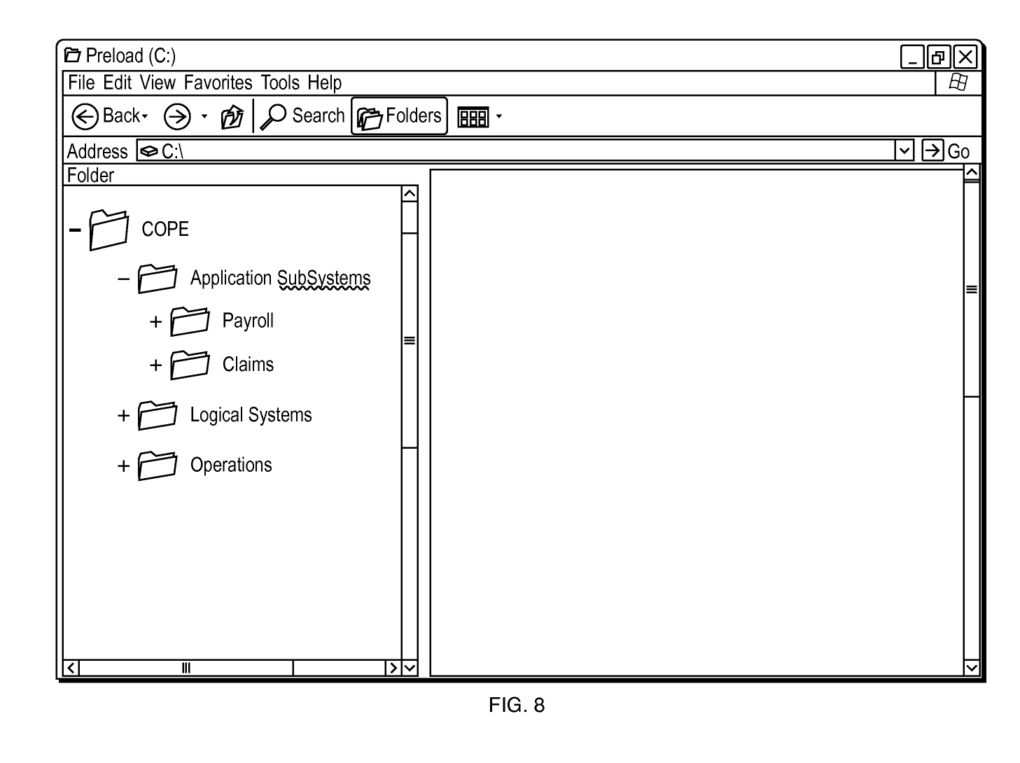

The COPE UI would display the Payroll and Claims Application SubSystems (see FIG. 8) that were retrieved from the COPESERV Service and sent to the COPE UI in XML. Below in Table 1 is a sample of the XML that would be the output from the COPESERV Service and displayed in the COPE UI.

TABLE 1
<ci:CICE_ROOT>

<ci:CICE_Commands>

<ci:Commands>DISPLAY</ci:Commands>

</ci:CICE_Commands>
<ci:Appl_Subsystem>

<ci:Name>Payroll</ci:Name>
<ci:Description>PAYROLL
SYSTEM</ci:Description>

</ci:Appl_Subsystem>

<ci:Appl_Subsystem>

<ci:Name>Claims</ci:Name>
<ci:Description>CLAIMS SYSTEM</ci:Description>

</ci:Appl_Subsystem>

</ci:CICE_ROOT>

Sample 2. URI=/COPESERV/{COPE_PSYS}/Appl_Subsystem/Payroll/Programs/

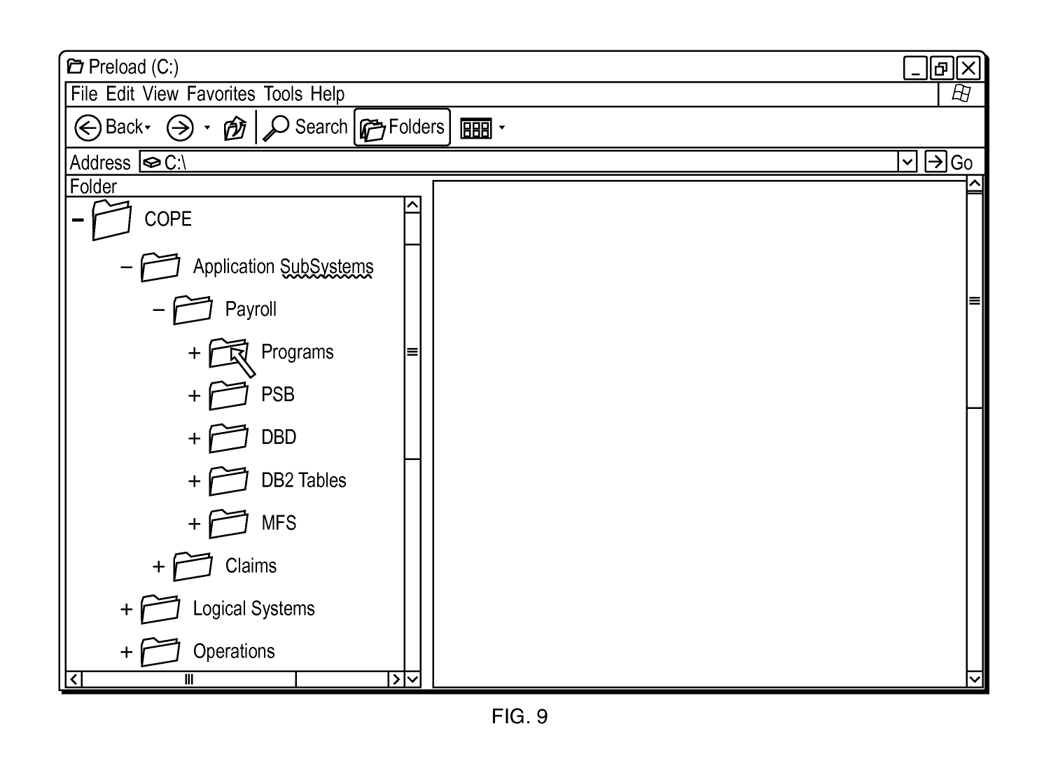

Sample 2 URI would be generated by the COPE UI when the RD/z user selected the Application SubSubsystem, Payroll, Programs folder (see FIG. 9). The URI would be sent to the COPESERV Service which would retrieve all the Programs for the Payroll Application Subsystem.

This is an example of a {resource type}/{resource name}/{resource type)/URI.

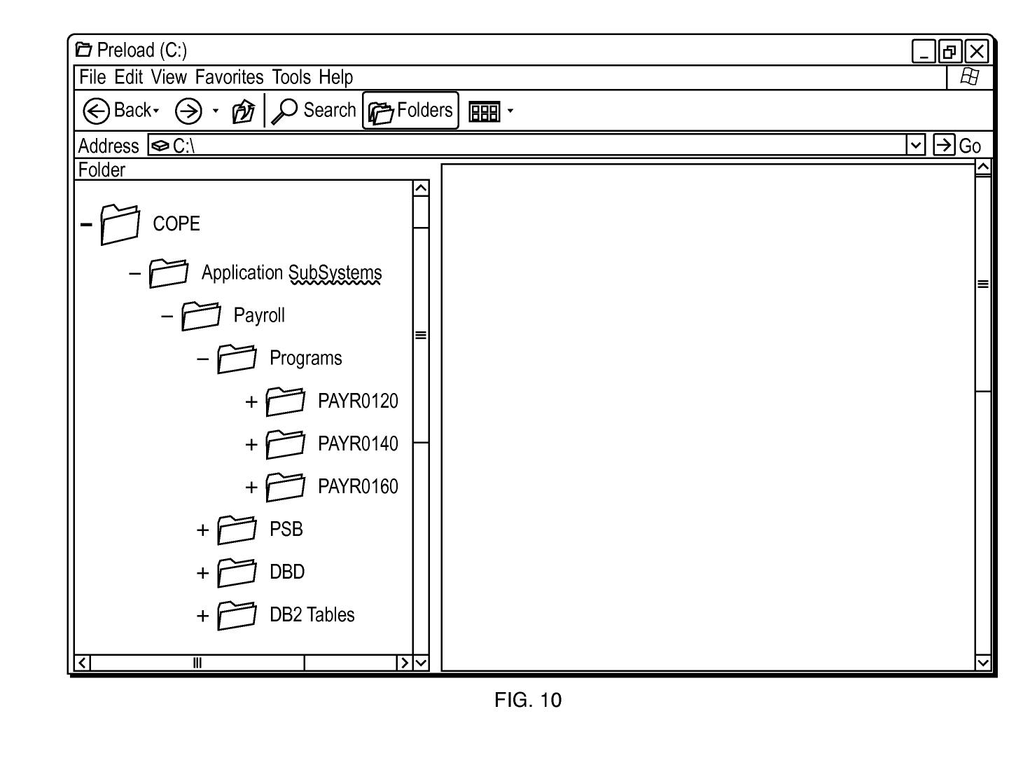

The COPE UI would display all the Programs for the Payroll Application SubSystem (see FIG. 10) that were retrieved from the COPESERV Service and sent to the COPE UI in XML. Below in Table 2 is a sample of the XML that would be the output from the COPESERV Service and displayed in the COPE UI.

```
TABLE 2
<ci:Appl_Subsystem>
  <ci:Name>PAYROLL</ci:Name>
  <ci:Description>PAYROLL SYSTEM</ci:Description>
  <ci:Programs>
```

<ci:Program_Name>PAYR0120</ci:Program_Name>
<ci:SubProgram>
<ci:SubProgram_Name>PAYW010<ci:SubProgram_Name>
</ci:SubProgram>
<ci:Uses_DB2>N</ci:Uses_DB2>
<ci:Uses_DLI>Y</ci:Uses_DLI>
<ci:PSB_NAME>PAYR0120</ci:PSB_NAME>

```
  </ci:Programs>
  <ci:Programs>
```

<ci:Program_Name>PAYR0140</ci:Program_Name>
<ci:Uses_DB2>N</ci:Uses_DB2>
<ci:Uses_DLI>Y</ci:Uses_DLI>
<ci:PSB_NAME>PAYR0140</ci:PSB_NAME>

```
  </ci:Programs>
  <ci:Programs>
```

<ci:Program_Name>PAYR0160</ci:Program_Name>
<ci:Uses_DB2>N</ci:Uses_DB2>
<ci:Uses_DLI>Y</ci:Uses_DLI>
<ci:PSB_NAME>PAYR0160</ci:PSB_NAME>

</ci:Programs>
</ci:Appl_Subsystem>

### COPESERV Component Services

### COPESERV Description

The overall design of the COPESERV Service requires TCP/IP Communication, XML Parsing, and a TSO/ISPF interface.

The TCP/IP Socket Service provides the communication with the COPE UI client and calls all the necessary programs to pass data between the COPE UI and the COPE application.

The XML Service generates the output XML from the CICECMDS Dsect which is returned from the TSO/ISPF interface.

The TSO/ISPF interface will be responsible for all data pushed and pulled from the COPE application.

### COPE Application Description

The TSO/ISPF interface will pass the URI from the COPE UI to the COPE application. The COPE application will build and populate the CICEXMLS Dsect and pass it back to the TSO/ISPF interface which will return it to the XML Service for generating the XML.

The COPE Application will be responsible for gathering all the table data needed for the COPE UI to display including column headings and data fields.

### Data Structures

### CICE_XML Scheme (FIG. 11)

This scheme was generated using the XMLSPY Tool from Altova.

### CICEXMLS DSECT (Table 3)

CICEXMLS has many Dsects to allow for the different request that may flow from the COPE Application and the COPE UI. The XML Service will use these Dsects to produce the XML needed for the COPE UI to process the COPE Application data. The Dsects are constructed to allow many types of different data structures via a common header that all the Dsects share (see HEAD_DSECT).

The CCMD_DSECT populates the commands for the COPE UI to process against a data selection via the COPE ICE panel and row commands.

The AFLD_DSECT populates the data fields that the COPE UI will display. Headings for each of the columns are included in this Dsect for the COPE UI and are flagged with begin and end markers. The data fields for a row will also have begin and end markers so the COPE UI will know how many fields are in a row to display.

TABLE 3

| ********************************************************************** | | * | 00010000 |
|---|---|---|---|
| * | | * | 00020000 |
| * | | * | 00030000 |
| * COPY NAME: | CICEXMLS | * | 00040000 |
| * | | * | 00050000 |
| * TITLE: | COPE ICE XML SERVICE DSECT | * | 00060000 |
| * | | * | 00070000 |
| * AUTHOR: | Rick Jones | * | 00080000 |
| * | October 8,2010 | * | 00090000 |
| * | | * | 00100000 |

| | | | |
|---|---|---|---|
| * | Modifications - | * | 00110000 |

| | | | | |
|---|---|---|---|---|
| * | MM/DD/YY Name | Description | * | 00120000 |

| * | | | | * | 00130000 |
|---|---|---|---|---|---|
| * | | | | * | 00140000 |
| ********************************************************************** | | | | * | 00150000 |
| COPE_XMLS | DSECT | | | | 00160000 |
| XMLS_LENGTH | DS | F | *LENGTH OF AREA | | 00170000 |
| XMLS_EYE_CATCHER | DS | CL8 | *EYECATCHER ‘CICEXMLS’ | | 00180000 |
| XMLS_START | EQU | * | *START OF COMMON HEADER | | 00190000 |
| | SPACE | 2 | | | 00200000 |
| ********************************************************************** | | | | * | 00210000 |
| * | | | | * | 00220000 |
| * COMMON HEADER DSECT | | | | * | 00230000 |
| * | | | | * | 00240000 |
| * HEAD_DSECT IS A COMMON DATA STRUCTURE FOR ALL THE FOLLOWING DSECTS | | | | * | 00250000 |
| * | | | | * | 00260000 |
| ********************************************************************** | | | | * | 00270000 |
| HEAD_DSECT | DSECT | | *COMMON HEADER DSECT | | 00280000 |
| HEAD_AREALEN | DS | F | *LENGTH OF AREA | | 00290000 |
| HEAD_NEXTAREA | DS | F | *ADDRESS OF NEXT HEADER AREA | | 00300000 |
| | SPACE | 1 | | | 00310000 |
| HEAD_ID | DS | XL1 | *TYPE OF NODE | | 00320000 |
| ********************************************************************** | | | | * | 00330000 |
| * | | | | * | 00340000 |
| * EQUATES TO DESCRIBE FIELD HEAD_ID | | | | * | 00350000 |
| * | | | | * | 00360000 |
| ********************************************************************** | | | | * | 00370000 |
| HEAD_COPE_PSYS | EQU 1 | | *COPE PSYS | | 00380000 |
| HEAD_COPE_COMMANDS | EQU 2 | | *COPE ICE APPLICATION COMMAND | | 00390000 |
| HEAD_COPE_APLFIELD | EQU 3 | | *COPE ICE APPLICATION FIELD | | 00400000 |
| HEAD_APPL_SUBSYSTEM | EQU 4 | | *APPLICATION SUBSYSTEM NODE | | 00410000 |
| HEAD_COPE_LSYS | EQU 5 | | *COPE LOGICAL SYSTEM NODE | | 00420000 |
| HEAD_COPE_OPERATION | EQU 6 | | *COPE OPERATION NODE | | 00430000 |
| HEAD_COPE_PROGRAM | EQU 7 | | *COPE PROGRAM NODE | | 00440000 |
| HEAD_COPE_SUBPROG | EQU 8 | | *COPE SUBPROGRAM NODE | | 00450000 |
| HEAD_COPE_PSBNAMES | EQU 9 | | *COPE PSB NAMES NODE | | 00460000 |
| HEAD_COPE_DBDNAMES | EQU 10 | | *COPE DBD NAMES NODE | | 00470000 |
| HEAD_COPE_DB2TABLE | EQU 11 | | *COPE DB2 TABLE NAMES NODE | | 00480000 |
| HEAD_COPE_JOBTRACK | EQU 12 | | *COPE JOB TRACKING NODE | | 00490000 |
| HEAD_COPE_MFS | EQU 13 | | *COPE MFS NODE | | 00500000 |
| HEAD_END | EQU 255 | | *END OF CICEXMLS AREA | | 00510000 |
| | DS | XL3 | *RESERVED FOR FUTURE USE | | 00520000 |
| HEAD_LENGTH | EQU | *-HEAD_DSECT | *LENGTH OF HEADER DSECT | | 00530000 |
| HEAD_START | EQU | * | *START OF DATA | | 00540000 |
| | SPACE | 2 | | | 00550000 |
| ********************************************************************** | | | | * | 00560000 |
| * | | | | * | 00570000 |
| * COPE PSYS DSECT | | | | * | 00580000 |
| * | | | | * | 00590000 |
| ********************************************************************** | | | | * | 00600000 |
| PSYS_DSECT | DSECT | | *COPE PHYSICAL SYSTEM DSECT | | 00610000 |
| PSYS_AREALEN | DS | F | *LENGTH OF AREA | | 00620000 |
| PSYS_NEXTAREA | DS | F | *ADDRESS OF NEXT AREA | | 00630000 |
| PSYS_ID | DS | XL1 | *EQUATE TO HEAD_COPE_PSYS | | 00640000 |
| | DS | XL3 | *RESERVED FOR FUTURE USE | | 00650000 |
| ***** END OF HEAD_DSECT COMMON AREA MAPPING ***** | | | | | 00660000 |
| | SPACE | 1 | | | 00670000 |
| PSYS_NAME | DS | CL8 | *COPE PHYSICAL SYSTEM NAME | | 00680000 |
| PSYS_DESCRIPTION | DS | CL44 | *PHYSICAL SYSTEM DESCRIPTION | | 00690000 |
| PSYS_LENGTH | EQU | *-PSYS_DSECT | *LENGTH OF PSYS AREA DSECT | | 00700000 |
| | SPACE | 2 | | | 00710000 |
| ********************************************************************** | | | | * | 00720000 |
| * | | | | * | 00730000 |
| * COPE ICE APPLICATION COMMANDS | | | | * | 00740000 |
| * | | | | * | 00750000 |
| ********************************************************************** | | | | * | 00760000 |
| CCMD_DSECT | DSECT | | *COPE PHYSICAL SYSTEM DSECT | | 00770000 |
| CCMD_AREALEN | DS | F | *LENGTH OF AREA | | 00780000 |
| CCMD_NEXTAREA | DS | F | *ADDRESS OF NEXT AREA | | 00790000 |
| CCMD_ID | DS | XL1 | *EQUATE TO HEAD_COPE_COMMANDS | | 00800000 |
| | DS | XL3 | *RESERVED FOR FUTURE USE | | 00810000 |
| ***** END OF HEAD_DSECT COMMON AREA MAPPING ***** | | | | | 00820000 |
| | SPACE | 1 | | | 00830000 |
| CCMD_TYPE | DS | XL1 | *COPE APPLICATION COMMAND TYPE | | 00840001 |
| CCMD_TYPE_PANEL | EQU | X‘80’ | *EQUATE FOR PANEL COMMAND | | 00850001 |
| CCMD_TYPE_ROW | EQU | X‘40’ | *EQUATE FOR ROW COMMAND | | 00860001 |
| CCMD_COMMAND_LEN | DS | XL1 | *LENGTH OF COMMAND | | 00870000 |
| CCMD_COMMAND_VALUE | EQU | * | *COMMAND COMMAND | | 00880000 |
| CCMD_LENGTH | EQU | *-CCMD_DSECT | *LENGTH OF CCMD AREA DSECT | | 00890000 |
| | SPACE | 2 | | | 00900000 |
| ********************************************************************** | | | | * | 00910000 |
| * | | | | * | 00920000 |
| * COPE APPLICATION FIELDS DSECT | | | | * | 00930000 |
| * | | | | * | 00940000 |
| ********************************************************************** | | | | * | 00950000 |
| AFLD_DSECT | DSECT | | *COPE JOB TRACKING DSECT | | 00960000 |
| AFLD_AREALEN | DS | F | *LENGTH OF AREA | | 00970000 |
| AFLD_NEXTAREA | DS | F | *POINTER TO NEXT JOB TRACK AREA | | 00980000 |
| AFLD_ID | DS | XL1 | *EQUATE TO HEAD_COPE_OPER | | 00990000 |
| | DS | XL3 | *RESERVED FOR FUTURE USE | | 01000000 |
| * | | | | | 01010000 |
| ***** END OF HEAD_DSECT COMMON AREA MAPPING ***** | | | | | 01020000 |
| * | | | | | 01030000 |
| AFLD_TYPE | DS | XL1 | *FIELD CHARACTERISTICS | | 01040001 |
| AFLD_TYPE_HEADING | EQU | X‘80’ | *HEADING FIELD | | 01050001 |
| AFLD_TYPE_KEY | EQU | X‘40’ | *KEY FIELD FOR TABLE ROW | | 01060001 |
| AFLD_TYPE_BEGIN | EQU | X‘20’ | *BEGIN OF ROW HEADING OR DATA | | 01080002 |
| AFLD_TYPE_END | EQU | X‘10’ | *END OF ROW HEADING OR DATA | | 01090002 |
| | SPACE | 1 | | | 01100000 |
| AFLD_FIELD_LEN | DS | XL2 | *LENGTH OF DATA FIELD | | 01110000 |
| AFLD_FIELD_VALUE | EQU | * | *START OF DATA FIELD | | 01120000 |
| AFLD_LENGTH | EQU | *-AFLD_DSECT | *LENGTH OF AFLD AREA DSECT | | 01130000 |
| | SPACE | 2 | | | 01140000 |
| ********************************************************************** | | | | * | 01150000 |
| * | | | | * | 01160000 |
| * APPLICATION SUBSYSTEM DSECT | | | | * | 01170000 |
| * | | | | * | 01180000 |
| ********************************************************************** | | | | * | 01190000 |
| ASUB_DSECT | DSECT | | *APPLICATION SUBSYSTEM DSECT | | 01200000 |
| ASUB_AREALEN | DS | F | *LENGTH OF AREA | | 01210000 |
| ASUB_NEXTAREA | DS | F | *ADDRESS OF NEXT ASUB AREA | | 01220000 |
| ASUB_ID | DS | XL1 | *EQUATE TO HEAD_APPL_SUBSYSTEM | | 01230000 |
| | DS | XL3 | *RESERVED FOR FUTURE USE | | 01240000 |
| * | | | | | 01250000 |
| ***** END OF HEAD_DSECT COMMON AREA MAPPING ***** | | | | | 01260000 . |
| * | | | | | 01270000 |
| ASUB_NAME | DS | CL8 | *APPL SUBSYS NAME | | 01280000 |
| ASUB_DESCRIPTION | DS | CL44 | *APPL DESCRIPTION | | 01290000 |
| ASUB_PROGRAM | DS | F | *POINTER TO PROGRAM NODE | | 01300000 |
| ASUB_PSB | DS | F | *POINTER TO PSB NODE | | 01310000 |
| ASUB_DBD | DS | F | *POINTER TO DBD NODE | | 01320000 |
| ASUB_DB2TABLE | DS | F | *POINTER TO DB2 TABLE NODE | | 01330000 |
| ASUB_LENGTH | EQU | *-ASUB_DSECT | *LENGTH OF SUBSYSTEM AREA VALUE | | 01340000 |
| | SPACE | 2 | | | 01350000 |
| ********************************************************************** | | | | * | 01360000 |
| * | | | | * | 01370000 |
| * COPE LOGICAL SYSTEM DSECT | | | | * | 01380000 |
| * | | | | * | 01390000 |
| ********************************************************************** | | | | * | 01400000 |
| LSYS_DSECT | DSECT | | *APPLICATION SUBSYSTEM DSECT | | 01410000 |
| LSYS_AREALEN | DS | F | *LENGTH OF AREA | | 01420000 |
| LSYS_NEXTAREA | DS | F | *POINTER TO NEXT LSYS AREA | | 01430000 |
| LSYS_ID | DS | XL1 | *EQUATE TO HEAD_COPE_LSYS | | 01440000 |
| | DS | XL3 | *RESERVED FOR FUTURE USE | | 01450000 |
| * | | | | | 01460000 |
| ***** END OF HEAD_DSECT COMMON AREA MAPPING ***** | | | | | 01470000 |
| * | | | | | 01480000 |
| LSYS_NAME | DS | CL8 | *COPE LSYS NAME | | 01490000 |
| LSYS_DESCRIPTION | DS | CL44 | *COPE LSYS DESCRIPTION | | 01500000 |
| LSYS_APPL_SUBSYS | DS | F | *POINTER TO APPL SUBSYS NODE | | 01510000 |
| LSYS_NODELEN | EQU | *-LSYS_DSECT | *LENGTH OF LSYS AREA VALUE | | 01520000 |
| | SPACE | 2 | | | 01530000 |
| ********************************************************************** | | | | * | 01540000 |
| * | | | | * | 01550000 |
| * COPE OPERATION DSECT | | | | * | 01560000 |
| * | | | | * | 01570000 |
| ********************************************************************** | | | | * | 01580000 |
| OPER_DSECT | DSECT | | *COPE OPERATION DSECT | | 01590000 |
| OPER_AREALEN | DS | F | *LENGTH OF AREA | | 01600000 |
| OPER_NEXTAREA | DS | F | *POINTER TO NEXT OPERATION AREA | | 01610000 |
| OPER_ID | DS | XL1 | *EQUATE TO HEAD_COPE_OPER | | 01620000 |
| | DS | XL3 | *RESERVED FOR FUTURE USE | | 01630000 |
| * | | | | | 01640000 |
| ***** END OF HEAD_DSECT COMMON AREA MAPPING ***** | | | | | 01650000 |
| * | | | | | 01660000 |
| OPER_DESCRIPTION | DS | CL44 | *COPE OPER DESCRIPTION | | 01670000 |
| OPER_OPERATION | DS | CL8 | *COPE OPER OPERATION | | 01680000 |
| OPER_REPLACE | DS | CL1 | *COPE OPER REPLACE (Y/N) | | 01690000 |
| OPER_OBJECTS | DS | CL8 | *COPE OPER OBJECT TYPE | | 01700000 |
| OPER_FROMLSYS | DS | CL8 | *COPE OPER FROM LOGICAL SYSTEM | | 01710000 |
| OPER_TOLSYS | DS | CL8 | *COPE OPER TO LOGICAL SYSTEM | | 01720000 |
| OPER_DATE | DS | CL8 | *COPE OPER DATE | | 01730000 |
| OPER_TIME | DS | CL8 | *COPE OPER TIME | | 01740000 |
| OPER_JOBTRACK | DS | F | *COPE POINTER TO JOB TRACK NODE | | 01750000 |
| OPER_NODELEN | EQU | *-OPER_DSECT | *LENGTH OF OPER AREA VALUE | | 01760000 |
| | SPACE | 2 | | | 01770000 |
| ********************************************************************** | | | | * | 01780000 |
| * | | | | * | 01790000 |
| * COPE PROGRAM DSECT | | | | * | 01800000 |
| * | | | | * | 01810000 |
| ********************************************************************** | | | | * | 01820000 |
| PROG_DSECT | DSECT | | *PROGRAM DSECT | | 01830000 |
| PROG_AREALEN | DS | F | *LENGTH OF AREA | | 01840000 |
| PROG_NEXTAREA | DS | F | *ADDRESS OF NEXT PROG AREA | | 01850000 |
| PROG_ID | DS | XL1 | *EQUATE TO HEAD_APPL_SUBSYSTEM | | 01860000 |
| | DS | XL3 | *RESERVED FOR FUTURE USE | | 01870000 |
| * | | | | | 01880000 |
| ***** END OF HEAD_DSECT COMMON AREA MAPPING ***** | | | | | 01890000 |
| * | | | | | 01900000 |
| PROG_NAME | DS | CL8 | *PROGRAM NAME | | 01910000 |
| PROG_SUBPROG | DS | F | *POINTER TO SUB PROGRAM NODE | | 01920000 |
| PROG_USESDB2 | DS | XL1 | *PROGRAM USES DB2 (Y/N) | | 01930000 |
| PROG_USESDLI | DS | XL1 | *PROGRAM USES DLI (Y/N) | | 01940000 |
| PROG_PSBNAME | DS | CL8 | *PROGRAM PSB NAME | | 01950000 |
| PROG_OPERSTATUS | DS | CL8 | *PROGRAM OPERATION STATUS | | 01960000 |
| PROG_LENGTH | EQU | *-PROG_DSECT | *LENGTH OF SUBSYSTEM AREA VALUE | | 01970000 |
| | SPACE | 2 | | | 01980000 |
| ********************************************************************** | | | | * | 01990000 |
| * | | | | * | 02000000 |
| * COPE SUBPROGRAM DSECT | | | | * | 02010000 |
| * | | | | * | 02020000 |
| ********************************************************************** | | | | * | 02030000 |
| SUBP_DSECT | DSECT | | *SUB PROGRAM DSECT | | 02040000 |
| SUBP_AREALEN | DS | F | *LENGTH OF AREA | | 02050000 |
| SUBP_NEXTAREA | DS | F | *ADDRESS OF NEXT SUBP AREA | | 02060000 |
| SUBP_ID | DS | XL1 | *EQUATE TO HEAD_APPL_SUBSYSTEM | | 02070000 |
| | DS | XL3 | *RESERVED FOR FUTURE USE | | 02080000 |
| * | | | | | 02090000 |
| ***** END OF HEAD_DSECT COMMON AREA MAPPING ***** | | | | | 02100000 |
| * | | | | | 02110000 |
| SUBP_NAME | DS | CL8 | *SUB PROGRAM NAME | | 02120000 |
| SUBP_LENGTH | EQU | *-SUBP_DSECT | *LENGTH OF SUBPROGRAM AREA | | 02130000 |
| | SPACE | 2 | | | 02140000 |
| ********************************************************************** | | | | * | 02150000 |
| * | | | | * | 02160000 |
| * COPE PSB DSECT | | | | * | 02170000 |
| * | | | | * | 02180000 |
| ********************************************************************** | | | | * | 02190000 |
| CPSB_DSECT | DSECT | | *COPE PSB DSECT | | 02200000 |
| CPSB_AREALEN | DS | F | *LENGTH OF AREA | | 02210000 |
| CPSB_NEXTAREA | DS | F | *ADDRESS OF NEXT SUBP AREA | | 02220000 |
| CPSB_ID | DS | XL1 | *EQUATE TO HEAD_APPL_SUBSYSTEM | | 02230000 |
| | DS | XL3 | *RESERVED FOR FUTURE USE | | 02240000 |
| * | | | | | 02250000 |
| ***** END OF HEAD_DSECT COMMON AREA MAPPING ***** | | | | | 02260000 |
| * | | | | | 02270000 |
| CPSB_NAME | DS | CL8 | *PSB NAME | | 02280000 |
| CPSB_DBD | DS | F | *POINTER TO DBD | | 02290000 |
| CPSB_LENGTH | EQU | *-CPSB_DSECT | *LENGTH OF PSB AREA | | 02300000 |
| | SPACE | 2 | | | 02310000 |
| ********************************************************************** | | | | * | 02320000 |
| * | | | | * | 02330000 |
| * COPE DBD DSECT | | | | * | 02340000 |
| * | | | | * | 02350000 |
| ********************************************************************** | | | | * | 02360000 |
| CDBD_DSECT | DSECT | | *COPE DBD DSECT | | 02370000 |
| CDBD_AREALEN | DS | F | *LENGTH OF AREA | | 02380000 |
| CDBD_NEXTAREA | DS | F | *ADDRESS OF NEXT CDBD AREA | | 02390000 |
| CDBD_ID | DS | XL1 | *EQUATE TO HEAD_APPL_SUBSYSTEM | | 02400000 |
| | DS | XL3 | *RESERVED FOR FUTURE USE | | 02410000 |
| * | | | | | 02420000 |
| ***** END OF HEAD_DSECT COMMON AREA MAPPING ***** | | | | | 02430000 |
| * | | | | | 02440000 |
| CDBD_NAME | DS | CL8 | *PSB NAME | | 02450000 |
| CDBD_LENGTH | EQU | *-CDBD_DSECT | *LENGTH OF DBD AREA | | 02460000 |
| | SPACE | 2 | | | 02470000 |
| ********************************************************************** | | | | * | 02480000 |
| * | | | | * | 02490000 |
| * COPE DB2 DSECT | | | | * | 02500000 |
| * | | | | * | 02510000 |
| ********************************************************************** | | | | * | 02520000 |
| CDB2_DSECT | DSECT | | *COPE DBD DSECT | | 02530000 |
| CDB2_AREALEN | DS | F | *LENGTH OF AREA | | 02540000 |
| CDB2_NEXTAREA | DS | F | *ADDRESS OF NEXT CDB2 AREA | | 02550000 |
| CDB2_ID | DS | XL1 | *EQUATE TO HEAD_APPL_SUBSYSTEM | | 02560000 |
| | DS | XL3 | *RESERVED FOR FUTURE USE | | 02570000 |
| * | | | | | 02580000 |
| ***** END OF HEAD_DSECT COMMON AREA MAPPING ***** | | | | | 02590000 |
| * | | | | | 02600000 |
| CDB2_NAME | DS | CL8 | *DB2 TABLE NAME | | 02610000 |
| CDB2_LENGTH | EQU | *-CDB2_DSECT | *LENGTH OF DBD AREA | | 02620000 |
| | SPACE | 2 | | | 02630000 |
| ********************************************************************** | | | | * | 02640000 |
| * | | | | * | 02650000 |
| * COPE JOB TRACKING DSECT | | | | * | 02660000 |
| * | | | | * | 02670000 |
| ********************************************************************** | | | | * | 02680000 |
| JOBT_DSECT | DSECT | | *COPE JOB TRACKING DSECT | | 02690000 |
| JOBT_AREALEN | DS | F | *LENGTH OF AREA | | 02700000 |
| JOBT_NEXTAREA | DS | F | *POINTER TO NEXT JOB TRACK AREA | | 02710000 |
| JOBT_ID | DS | XL1 | *EQUATE TO HEAD_COPE_OPER | | 02720000 |
| | DS | XL3 | *RESERVED FOR FUTURE USE | | 02730000 |
| * | | | | | 02740000 |
| ***** END OF HEAD_DSECT COMMON AREA MAPPING ***** | | | | | 02750000 |
| * | | | | | 02760000 |
| JOBT_DESCRIPTION | DS | CL44 | *COPE JOBT DESCRIPTION | | 02770000 |
| JOBT_JCLMEMBER | DS | CL8 | *COPE JOBT JCL MEMBER | | 02780000 |
| JOBT_USERID | DS | CL8 | *COPE JOBT USERID | | 02790000 |
| JOBT_STATUS | DS | CL8 | *COPE JOBT STATUS | | 02800000 |
| JOBT_JOBNAME | DS | CL8 | *COPE JOBT JOB NAME | | 02810000 |
| JOBT_ALLOWRC | DS | F | *COPE JOBT ALLOWABLE RETURN CODE | | 02820000 |
| JOBT_JOBRC | DS | F | *COPE JOBT RETURN CODE | | 02830000 |
| JOBT_SEQNUMBER | DS | F | *COPE JOBT SEQUESCE NUMBER | | 02840000 |
| JOBT_NODELEN | EQU | *-JOBT_DSECT | *LENGTH OF JOBT AREA VALUE | | 02850000 |
| | SPACE | 2 | | | 02860000 |
| ********************************************************************** | | | | * | 02870000 |
| * | | | | * | 02880000 |
| * COPE MFS DSECT | | | | * | 02890000 |
| * | | | | * | 02900000 |
| ********************************************************************** | | | | * | 02910000 |
| MFSS_DSECT | DSECT | | *COPE MFS DSECT | | 02920000 |
| MFSS_AREALEN | DS | F | *LENGTH OF AREA | | 02930000 |
| MFSS_NEXTAREA | DS | F | *POINTER TO NEXT JOB TRACK AREA | | 02940000 |
| MFSS_ID | DS | XL1 | *EQUATE TO HEAD_COPE_OPER | | 02950000 |
| | DS | XL3 | *RESERVED FOR FUTURE USE | | 02960000 |
| * | | | | | 02970000 |
| ***** END OF HEAD_DSECT COMMON AREA MAPPING ***** | | | | | 02980000 |
| * | | | | | 02990000 |

| | | | | |
|---|---|---|---|---|
| MFSS_NAME | DS | CL8 | *MFS SCREEN NAME | 03000000 |
| MFSS_LENGTH | EQU | *-MFSS_DSECT | *LENGTH OF MFS AREA | 03010000 |

It should now be readily apparent to those skilled in the art that a novel system, process and article of manufacture capable of achieving the stated objects of the invention has been provided. The system, process and article of manufacture of this invention automatically provisions software incorporating a subset of preexisting database management applications and their related artifacts. The system, process and article of manufacture minimizes or eliminates the need for human involvement after an initial request for automatic provisioning. The system, process and article of manufacture creates a virtual system for the automatic provisioning.

It should further be apparent to those skilled in the art that various changes in form and details of the invention as shown and described may be made. The system, process and article of manufacture is described by way of example in an IMS embodiment. The invention can be implemented in other database management system environments. It is intended that such changes be within the spirit and scope of this invention.

1. A system for the automatic generation of a subset of an existing database management application including a plurality of artifacts in said system, which comprises an input for receiving a user request to generate the subset from the existing database management application, a processing unit configured to create a virtual data processing machine in said system, said processing unit being further configured to create the subset of the existing database management application comprising less than the entire existing database management application in the virtual data processing machine.

2. The system of claim 1 in which the artifacts of the existing database management application comprise at least some of unrelated database management programs, database definitions, program specifications, DB2 plans, message format services and job control language statements.

3. The system of claim 2, in which the subset is of existing databases within the existing database management application.

4. The system of claim 3 in which said processing unit is configured to create the subset of the existing databases by parsing a source of the database definitions to find a relationship between different artifacts of the existing database management application.

5. The system of claim 4 in which said processing unit is configured to create the subset of the existing databases by parsing the source to derive the subset of the existing databases defined to one of the artifacts.

6. The system of claim 3 in which the subset includes a subset of existing database management system programs.

7. The system of claim 6, in which said processing unit is configured to create the subset of the existing database management system programs by parsing database management program source and execution libraries to derive the subset of related application programs.

8. The system of claim 1 in which the existing database management application is an IMS application.

9. A process for the automatic generation of a subset of an existing database management application including a plurality of artifacts in a data processing system, which comprises receiving a user request to generate the subset from the existing database management application, creating a virtual data processing machine in the data processing system, and creating a subset of the existing database management application comprising less than the entire existing database management application in the virtual data processing machine.

10. The process of claim 9, in which the artifacts of the existing database management application comprise at least some of unrelated database management programs, database definitions, program specifications, DB2 plans, message format services and job control language statements.

11. The process of claim 10 in which the subset is of existing databases within the existing database management application.

12. The process of claim 11 in which the instance of the program is the subset of the existing databases and is created by parsing a source of the database definitions to find a relationship between different artifacts of the existing database management application.

13. The process of claim 9 in which the subset the subset of the existing databases is created by parsing the source to derive the subset of the existing databases defined to one of the artifacts.

14. The process of claim 11 in which the subset includes a subset of existing database management system programs.

15. The process of claim 14 in which the subset of the existing database management system programs is created by parsing database management program source and execution libraries to derive the subset of related application programs.

16. The process of claim 9 in which the existing database management application is an IMS application.

17. An article of manufacture for the automatic generation of a subset of an existing database management application including a plurality of artifacts, which comprises a computer readable storage medium having stored therein a first program segment for receiving a user request to generate the subset from the existing database management application, a second program segment for creating a virtual data processing machine in the data processing system, and a third program segment for creating a subset of the existing database management application comprising less than the entire existing database management application in the virtual data processing machine.

18. The article of manufacture of claim 17 in which the artifacts of the existing database management application comprise at least some of unrelated database management programs, database definitions, program specifications, DB2 plans, message format services and job control language statements.

19. The article of manufacture of claim 18 in which the subset is of existing databases within the existing database management application.

20. The article of manufacture of claim 19 in which the third program segment is configured to create the subset of the existing databases by parsing a source of the database definitions to find a relationship between different artifacts of the existing database management application.

21. The article of manufacture of claim 20 in which the third program segment is configured to create subset of the existing program is created by by parsing the source to derive the subset of the existing databases defined to one of the artifacts.

22. The article of manufacture of claim 19 in which the subset is of existing database management system programs.

23. The article of manufacture of claim 22 in which the subset of the existing database management system programs is created by parsing database management program source and execution libraries to derive the subset of related application programs.

24. The article of manufacture of claim 17 in which the existing database management application is an IMS application.
